(19) United States
(12) Patent Application Publication
(10) Pub. No.: US 2014/0100098 A1
(43) Pub. Date: Apr. 10, 2014

(54) PACKAGING MATERIAL HAVING A DETECTABLE MARK FOR MANUFACTURING OF CARTON OR PAPERBOARD BASED PACKAGING CONTAINERS

(71) Applicants: Magnus Dahl, Staffanstorp (SE); Christer Andersson, Lund (SE); Jens Quist, Bjarred (SE)

(72) Inventors: Magnus Dahl, Staffanstorp (SE); Christer Andersson, Lund (SE); Jens Quist, Bjarred (SE)

(73) Assignee: Tetra Laval Holdings & Finance S.A., Pully (CH)

(21) Appl. No.: 14/122,910

(22) PCT Filed: May 23, 2012
(86) PCT No.: PCT/EP2012/059572

§ 371 Date: Nov. 27, 2013

(30) Foreign Application Priority Data
May 31, 2011 (SE) 1100428-0

(51) Int. Cl. B65H 43/08; B31B 1/74

(52) U.S. Cl. CPC B65H 43/08; B31B 1/74
USPC 493/11; 493/23

(57) ABSTRACT

A packaging material for manufacturing of carton or paperboard based packaging containers by fold-forming is disclosed. The packaging material is obtainable by: providing, in connection with one station, a first part of one or more crease line(s) and a first mark on a moving web of a paperboard or carton based packaging material providing, in connection with a second station, at least a second part of the one or more crease line(s) as well as a second mark, wherein the first and the second mark together form a detectable mark.

### TECHNICAL FIELD

The present invention relates to a crease-lined packaging material, and a method of manufacturing of a crease-lined packaging material from a web-shaped starting material which is provided with a pattern of crease lines and a mark that is provided by a first and a second roller.

### BACKGROUND OF THE INVENTION

In the production of packaging containers of a single-use disposable type for various types of drinks, e.g. juice and milk, use is often made of a laminated packaging material which is cut, folded and sealed for the formation of a liquid-tight, filled and sealed packaging container. A common material type consists of a laminate which comprises a central, relatively thick carrier layer of fibrous material, e.g. paper, which is coated on either side with layers of thermoplastic material. Possibly, other layers may also be included, for example barrier layers such as aluminium foil or some form of barrier plastic such as, for instance, EVOH. In order to facilitate the forming of the packaging container, the packaging laminate is weakened in a linear pattern of crease lines which, by compressing above all the carrier layer of the laminate, facilitate its folding. Normally, the crease lines extend both parallel to the longitudinal direction of the web and at different angles thereto, for example transversely or obliquely over the material web.

Printed marks to detect the longitudinal position of the web material have been used for many years, are simple to produce and easy to read; in facts, the printed mark is simply a portion of the package design and thus does not bring about any additional cost. However, being a portion of the printed design means that the register mark itself is not perfectly in register with the crease pattern, because printing and creasing steps are two different, successive steps in web material production and, although relative shifts between the two steps are kept to a minimum, there are inherent tolerances in the production process.

EP-A-0 772 760 discloses a method and device for detecting the position of a crease line of a packaging web material by means of a laser reflection technology, in particular by using two photodetectors detecting the light reflected by the material along two directions inclined with respect to the light incidence direction and by processing the signals thus obtained.

WO 03/037729 and WO 03/037722 disclose the use of crease lines for detecting both the longitudinal and transverse position of the web material.

DE-A-10246449 and EP-A-1 406 061 disclose a method of detecting the longitudinal and transverse position of a web packaging material by reading two mutually intersecting embossed lines by means of laser differential reflection technology similar to that disclosed in above-mentioned EP-A-0 772 760. This method, however, cannot provide all the data that are necessary to control the web feed because no information can be obtained on the web speed that is an essential parameter to be detected and must be determined in some other way.

Additional creasing operations are known. For example, schematically disclosed in FIG. 3, a web of packaging material A having top panels B, side wall panels C and bottom panels D arranged in the machine direction (MD) of the web is known. The panels, arranged in said order, are foldably connected to each other by transversal crease lines (TCT—transversal crease line top, and TCB transversal crease line bottom). Longitudinal crease lines 1-4 are shown and it is known that the longitudinal creasing lines may be applied from two directions allowing creasing of 1a, 2a, 3a and 4a in one and the same operation from one side of the packaging material web. The additional parts i.e. 1b, 1c; 2b, 2c; 3b, 3c; and 4b, 4c are provided in a second creasing operation from the opposite side of the packaging material web. The described two step creasing operation is particular useful for manufacturing packages having a vertical, tube shaped container body having substantially planar end closures. An example thereof is marketed as Tetra Prisma™ having a tube shaped container body with a substantially octagonal horizontal cross-section. In case of changes in for example web tension an impaired result, i.e. non-aligned crease lines, may occur.

One wish in the art of packaging material manufacture is therefore to realize a method of producing crease-lined packaging material and obtaining a sufficiently accurate end result, i.e. a packaging container having a well defined shape without compromising its integrity.

### SUMMARY OF THE INVENTION

An object of the present invention is to obtain a web of packaging material suitable for manufacturing of packaging containers such as carton or paperboard based packaging containers.

An object of the invention is to provide a method for manufacturing of packaging material suitable of being form-folded into packaging containers.

The invention relates to a packaging material for manufacturing of carton or paperboard based packaging containers by fold-forming, obtainable by providing in connection with one station a first part of one or more crease line(s) and a first mark on a moving web of a paperboard or carton based packaging material, providing in connection with a second station at least a second part of the one or more crease line(s) as well as a second mark, wherein the first and the second mark together form a detectable mark.

The invention also relates to a packaging container having substantially planar top and bottom parts and based on carton or paperboard obtained by folding, sealing, and cutting a packaging material as defined herein. The container in one aspect has a tube shaped container body having at least one end being substantially planar, and wherein the container body has a substantially square or rectangular cross-section.

The invention furthermore relates to a method for manufacturing a web of packaging material for forming carton or paperboard based packaging containers by folding, said web of packaging material being provided with an optional pattern of crease lines wherein at least one is oriented in a direction parallel to the longitudinal edges of the web, said method comprising the steps of: passing a web of carton or paperboard through a first station in which the web is provided with a first part of one or more longitudinal crease line(s); passing the web of carton or paperboard further through a second station in which the web is provided with at least a second part of said one or more longitudinal crease line(s), wherein said web at the first station is provided with a mark in alignment with said first part of said one or more longitudinal crease line(s), and wherein said web at the second station is provided with a second part mark in alignment with said second part of said one or more longitudinal crease line(s), said first and second part forming a detectable mark.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 schematically illustrates the method for providing a packaging laminate with a mark or embossment.

FIG. 2 schematically illustrates a part of the manufacturing line for packaging containers.

FIG. 3 schematically illustrates a packaging material web including the crease pattern.

### DETAILED DESCRIPTION OF PREFERRED EMBODIMENTS

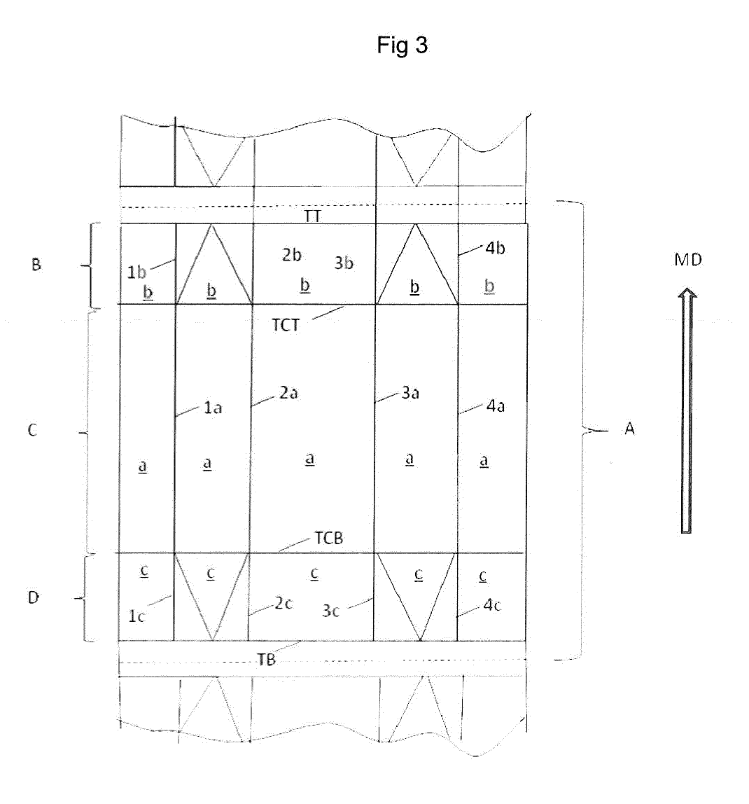

FIG. 3 schematically discloses a web-shaped packaging material A having top panels B, side wall panels C and bottom panels D arranged in the machine direction (MD) of the web is known. The panels, arranged in said order, are foldably connected to each other by transversal crease lines (TCT—transversal crease line top, and TCB transversal crease line bottom). Longitudinal crease lines 1-4 are shown. The longitudinal crease lines reaches between the transversal crease lines TT and TB (transversal crease line top and bottom respectively), FIG. 3 discloses that the longitudinal crease line parts 1a-4a together with TCT and TCB are foldably connected side wall panels a. The crease line parts 1b-4b of the longitudinal crease lines 1-4 together with TCT and TT are foldably connected top panels b. The crease line parts 1c-4c of the longitudinal crease lines 1-4 together with TCB and TB are foldably connected bottom panels c.

As described above it is known that the longitudinal creasing lines may be applied from two directions allowing creasing of 1a, 2a, 3a and 4a in one and the same station from one side of the web of packaging material. The additional parts i.e. 1b, 1c; 2b, 2c; 3b, 3c; and 4b, 4c are provided in a second creasing station from the opposite side of the web of packaging material. The creasing station, as just described, performed in two directions means that a packaging container having a defined geometrical outer shape including distinct longitudinal edges is obtained. The distinct longitudinal edges are created by creasing 1a, 2a, 3a and 4a, thus forming protruding and convex crease part arrange as the outside of the finished packaging container. Consequently the remaining parts 1b, 1c; 2b, 2c; 3b, 3c and 4b, 4c are formed by creasing in such a way that said parts are to be arranged on the inside of the final packaging container. The above mentioned arrangement of the creases thus allows for forming of more distinct package.

The described two step creasing is particular useful for manufacturing packages such as the one marketed as Tetra Prisma™ having a tube shaped container body with a substantially octagonal horizontal cross-section. An octagonal container body implies that the longitudinal, canted end walls are provided at an angle of about 135 degrees. The folding of the octagonal container body can also be seen as the wed of packaging material is to be folded 45 degrees from a flat transportation position. The above mentioned two step creasing applying the crease lines from two direction and where the 1b, 1c; 2b, 2c; 3b, 3c and 4b, 4c is suitable for such folding. However if the when using a two step creasing operation on a web of packaging material intended to be form folded to package having a tube shaped container body having a substantially rectangular or square cross-section, i.e a container body having vertical, canted end walls having about 90 degree angle to each other the alignment of the crease lines provided in the two creasing stations are more important.

Contrary to the above mentioned 45 degree folding, when folding a packaging container having side walls at a 90 degree angle, such as packaging containers having a container body having a square or rectangular based cross-section a close orientation and fitting of the longitudinal crease lines is beneficial in order to obtain a folded package having the desired geometrical shape. The folding operation from the substantially flat web is done by 90 degree folding. The skilled person realize that the precise orientation of the crease lines necessary to obtain the square or rectangular shaped container body by a two step creasing operation is more difficult as the separate creasing operations are to be performed on a moving web, for example at speeds above 500 m/min, such as about 600 m/min. The person skilled in the art additionally understands that the alignment between the 1a, 2a, 3a, 4a and 1b, 1c; 2b, 2c; 3b, 3c; and 4b, 4c (as they are provided in at least two creasing stations). For example an increase or decreases of the web tension may position the longitudinal crease lines in the second station in a non-aligned position compared to 1a, 2a, 3a, and 4a. Also other process related factors may affect the positioning of the crease lines. As can be seen for example in FIG. 3 the crease lines 1-4 are longitudinal crease lines provided parallel to the edges of the web. The longitudinal crease lines are also parallel to the direction of the conveyor belt, which is in the machine direction. The machine direction also corresponds to the direction of the fibers of the carton or paperboard.

It is thus an object of the present invention to perform the creasing in two creasing station without impairing or causing the creasing to be non-aligned, or at least to manufacture a web of packaging material on which it is easily detected that the crease lines provided in two separate creasing stations are not aligned.

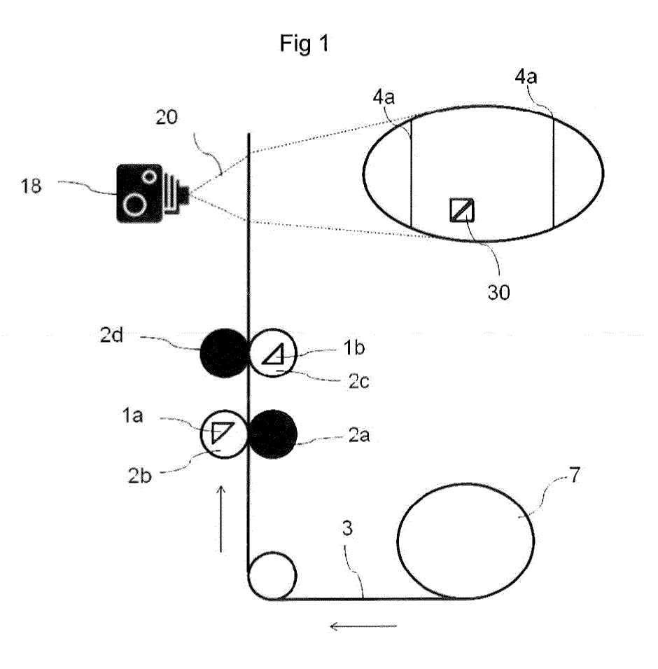

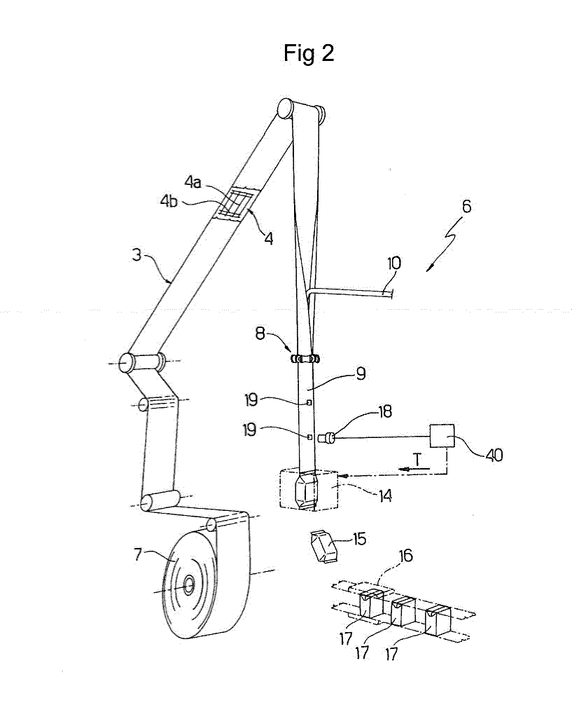

The invention has mainly been described above with reference to a few embodiments. However, as is readily appreciated by a person skilled in the art, other embodiments than the ones disclosed above are equally possible within the scope of the invention, as defined by the appended patent claims. FIG. 2 schematically illustrates a packaging machine where the web material 3 comprises a crease line pattern 4 and a the mark or embossment 30 provided as schematically illustrated in FIG. 1, as well as further described within the present specification. The crease line pattern 4 and a mark or embossment 5 are repeated at intervals R at least equal to the length of material required to produce one package. Crease line pattern 4 includes, in a known manner, a plurality of longitudinal crease lines 4a, corresponding to the vertical corners of the finished packages, and a plurality of transverse crease lines 4b corresponding to the horizontal corners of the package and the base of the transversal seal portions or “fins”. The mark or embossment 5 may be arranged wherever suitable at the web material, it should preferably not intersect with any of the crease lines 4a, 4b of the pattern 4.

The web material 3 can be used on a machine 6, schematically illustrated in FIG. 2, for producing aseptic packages, and on which web material 3 is unwound off a reel 7 and fed through an aseptic chamber (not shown), where it is sterilized, and through an assembly 8 by which it is folded and sealed longitudinally to form, in known manner, a continuous vertical tube 9. Tube 9 of packaging material is filled continuously with the pourable food product by means of a known filling device 10, and is then fed to a forming and transverse sealing station 14 where it is gripped between pairs of jaws (not shown) that seal the tube transversely to form pillow packs 15. Pillow packs 15 are then separated by cutting the sealing portion between the packs, and are fed to a final folding station 16 where they are folded mechanically to form the finished packages 17. The packages are formed by folding (form-folding) the material along crease lines 4a, and 4b and by controlling material feed by means of a controlling device 18 for “reading” the mark or embossment 5, located on the material at intervals R. The controlling device 18 may be arranged anywhere after the provision of the mark or embossment.

FIG. 2 schematically illustrates a part of a manufacturing line for packaging containers. In more detail FIG. 2 discloses a web material (3), for example a packaging material in the form of a laminate such as a fibrous based material, such as paperboard or carton or similar, forming the carrier layer of the laminate being provided with external, liquid-tight thermoplastic layers of, for example, polyethylene with the aid of a laminator unit. The plastic layers are extruded over the entire width of the web, and cooled compression rollers are employed to ensure that the plastic melts into and is permanently bonded to the fibrous material. Possible additional layers of, for example, aluminium foil may be applied, whereupon an external layer of liquid-tight thermoplastic completes the laminate production process. The web material is provided with the desired pattern of crease lines, which is realized with the aid of two pairs of cooperating (2a-d, respectively), counter-rotating rollers between which the web material passes. The rollers, which are provided with male 2b, 2c and female 2a, 2d tools, respectively, compress the packaging laminate so that the desired pattern of crease lines is obtained. Additionally the first male tool 2b is provided with a mark or embossing tool 1a making a mark or embossment in the web material, the second male tool 2c is provided with a complementary mark or embossing tool 1b. After passing the second pair of rollers the crease-lined web material having a mark or embossment passes a controlling device 18 comprising at least detection device, such as a camera and optionally a computing unit. The controlling device determines the positional relationship between the two marks 1a, 1b to determine if the mark or embossment forms a pre-defined shape or pattern. In one embodiment image analysis comparing the mark or embossment with a pre-defined mark is used. In one embodiment the controlling device is connected to an output device indicating if the formed mark or embossment forms the desired shape or pattern. In one embodiment the invention further comprises the step of outputting an error signal if the formed mark or embossment is outside the pre-defined limits. In one embodiment the invention additionally accomplishes a method of adjusting the transversal or longitudinal position of the web material, i.e. such that the positional relationship between the web material and the conveyor belt transporting the web material is altered in such a way that the formed mark or embossment is adjusted to be within pre-determined limits, i.e. the web tension is controlled to obtain alignment between the longitudinal crease lines provided in the two separate stations. Preferably the mark or embossment is arranged such that the detection by the controlling device is facilitated. In one embodiment the thickness of the mark is about half the thickness of the packaging material, although also other thicknesses are contemplated and within the scope of the present invention. In one preferred embodiment the first and second male tools 2c, 2d makes an impression in the web material and said impression forms the detectable mark. Optionally other marks are contemplated, for example a printed mark. The skilled person realizes that many marks are contemplated, as long as provided in connection with the first and the second creasing station and which marks together form a detectable mark. What is of importance is that the two marks forming the detectable mark are applied in connection with its respective creasing station as this align the marks with the crease line(s) provided at its respective creasing station. The design of the detectable marks is not of major importance for the invention but naturally certain geometrical shapes may beneficially as they are more easily detectable or it is more easily detected when they are not in the desired shape or pattern. Contemplated within the present invention are also apparatuses for performing the methods described herein.

Whenever the wording “controlling” is used within the present invention it is not to be construed as limiting and should for example include monitoring, regulating and directing as well as synonyms thereof.

The thus produced and crease-lined and marked web material is then divided by means of cutting tools into the desired number of parallel tributary or part webs, each one of which being of a width which corresponds to the width of the material consumed for producing one packaging container of the relevant type.

A carton or paperboard based packaging material or packaging container means a material or container where a substantial part is fibrous material, for example in the form of a laminate between plastic layer and a paperboard.

The end shape of a package is characterized by the fold notches created in the web material, i.e. the crease lines. If the mark or embossment provided by two pairs of rollers is used as a position reference at cutting, application and other processes the positioning of these can be performed with improved accuracy compared to the crease lines. Consequently less web material must be discarded and species variation, i.e. function and appearance, is decreased.

According to the invention a crease or crease line means a weakening in the material, for example provided by line made by pressing, folding, or wrinkling. Creasing thus means weakening, for example by means of pressing, folding, or wrinkling.

In view of the above mentioned embodiments and the accompanying claims and drawings objects of the present invention, i.e. to be able to obtain a sufficiently accurate end result in the manufacture of laminated crease-lined packaging material have been enabled. The provision of the detectable mark according to the present invention has advantages obvious to the skilled person and can in principle lead to improved manufacturing of packaging containers as well as improved packaging containers as the risk of folding where there is no crease line is decreased. The mark is easily obtained as exemplified above by providing the mark tools 1a, 1b the first and second male tools 2c, 2d and the resulting mark enable the possibility to determine that the web material is correctly positioned at least longitudinal direction.

1. A packaging material for manufacturing of carton or paperboard based packaging containers by fold-forming, obtainable by:
providing in connection with one station a first part of one or more crease line(s) and a first mark on a moving web of a paperboard or carton based packaging material,
providing in connection with a second station at least a second part of the one or more crease line(s) as well as a second mark,
wherein the first and the second mark together form a detectable mark.

2. The packaging material according to claim 1, wherein the one or more crease lines(s) is provided as longitudinal crease line(s) in a direction parallel to longitudinal edges of the moving web.

3. The packaging material according to claim 1, wherein the detectable mark is of a pre-determined geometrical shape.

4. The packaging material according to claim 1, wherein the first mark is aligned with the first part of the one or more crease line(s)s and the second mark is aligned with the second part of the one or more crease line(s).

5. The packaging material according to claim 1, wherein the at least a second part of the one or more crease line(s) compared to the first part of one or more crease line(s) is provided from the opposite side of the moving web.

6. A packaging container having substantially planar top and bottom parts and based on carton or paperboard obtained by folding, sealing, and cutting a packaging material according to claim 1.

7. The packaging container according to claim 6, wherein the container has a tube shaped container body having at least one end being substantially planar, and wherein the container body has a substantially square or rectangular cross-section.

8. (canceled)

9. A method for manufacturing a web of packaging material for forming carton or paperboard based packaging containers by folding, said web of packaging material being provided with an optional pattern of crease lines wherein at least one crease line is oriented in a direction parallel to the longitudinal edges of the web, said method comprising the steps of:
passing a web of carton or paperboard through a first station in which the web is provided with a first part of one or more longitudinal crease line(s);
passing the web of carton or paperboard through a second station in which the web is provided with at least a second part of said one or more longitudinal crease line(s),
wherein said web at the first station is provided with a mark in alignment with said first part of said one or more longitudinal crease line(s), and
wherein said web at the second station is provided with a second part mark in alignment with said second part of said one or more longitudinal crease line(s); said first and second part forming a detectable mark.

10. The method according to claim 9, wherein the detectable mark is of a pre-determined geometrical shape or figure.

11. The method according to claims 9 or 10, wherein the thickness of the detectable mark is about half the thickness of the web of packaging material.

12. The method according to claim 9, wherein said detectable mark is visually detectable or magnetically detectable.

13. The method according to claim 9, wherein the web of packaging material provided with the detectable mark is passing a controlling device, wherein the controlling device determines if the pre-determined geometrical shape is within a pre-defined tolerance.

14. The method according to claim 9, wherein an error signal is generated when the pre-determined shape is not within the pre-defined tolerance.

15. The method according to claim 9, wherein the longitudinal position of the web material is adjusted when the pre-determined shape is not within the pre-defined tolerance.

16. The method according to claim 13, wherein the controlling device at least comprises a camera.

17. The method according to claim 13, wherein the controlling device further comprises an output device.

18. The method of according to claim 9, wherein the web material is a laminate.

19. The method according to claim 9, wherein the at least a second part of the one or more longitudinal crease line(s) compared to the first part of one or more crease line(s) is provided the opposite side of the moving web.
